(19) United States
(12) Patent Application Publication
(10) Pub. No.: US 2026/0106525 A1
(43) Pub. Date: Apr. 16, 2026

(54) VARIABLE SKEW PERMANENT MAGNET MOTOR

(71) Applicant: FORD GLOBAL TECHNOLOGIES, LLC, Dearborn, MI (US)

(72) Inventors: Jonathan Hair, Northville, MI (US); Nicholas Church, Allen Park, MI (US); Brendan F. Diamond, Naples, FL (US); Matthew Penne, Pierce, NE (US)

(21) Appl. No.: 18/914,581

(22) Filed: Oct. 14, 2024

(51) Int. Cl. H02K 15/00; H02K 1/276; H02K 7/00

(52) U.S. Cl. CPC H02K 15/50; H02K 1/276; H02K 7/003; H02K 2201/06; H02K 2213/09

(57) ABSTRACT

A permanent magnet synchronous motor includes a rotor permitting dynamic adjustment of a degree of skew. A hollow shaft slides axially with respect to the rotor shaft. The rotor plates are coupled to the hollow shaft such that they rotate with respect to one another in response to axial movement of the hollow shaft. A process for adjusting the skew includes reducing torque, releasing clamping force, and providing supplemental lubrication before moving the hollow shaft.

### TECHNICAL FIELD

This disclosure pertains to electric motors. More particularly, this disclosure pertains to a permanent magnet motor having a rotor with variable skew.

### BACKGROUND

Many electrified vehicles utilize permanent magnet synchronous traction motors. The torque produced by these motors tends to have a cyclical variation called torque ripple. One way to mitigate torque ripple is to skew the rotor plates slightly relative to one another such that the torque ripple produced by each rotor plate is slightly out of phase from the others.

### SUMMARY

A rotor includes a rotor shaft, a hollow shaft, and a plurality of rotor plates. The hollow shaft is configured to slide axially with respect to the rotor shaft. The hollow shaft has at least one external spiral key. In some embodiments, the hollow shaft may have a plurality of external spiral keys having different spiral angles from one another. The plurality of rotor plates are arranged along the hollow shaft. At least one of the rotor plates is a variable skew rotor plate. Each variable skew rotor plates defines a keyseat interfacing with the external spiral key such that the variable skew rotor plate rotates with respect to the rotor shaft in response to axial movement of the hollow shaft. The plurality of rotor plates may also include at least one fixed rotor plate which does not rotate with respect to the rotor shaft in response to axial movement of the hollow shaft. An end stop may be fixed to the rotor shaft and configured to axially position the plurality of rotor plates on one end with respect to the rotor shaft. A cylinder may be fixed to the rotor shaft on an opposite side of the plurality of rotor plates from the end stop. A piston may be configured to slide with respect to the cylinder toward the end stop in response to hydraulic pressure to selectively compress the plurality of rotor plates. The hollow shaft and either the end stop or the cylinder may define a first chamber such that injecting pressurized fluid into the first chamber moves the hollow shaft axially in a first direction. The hollow shaft and either the end stop or the cylinder may further define a second chamber such that injecting pressurized fluid into the second chamber moves the hollow shaft axially in a second direction opposite the first direction. The rotor shaft may define an axial passageway and the rotor shaft and the hollow shaft may each define radial passageways configured to route lubrication fluid to spaces between the rotor plates of the plurality of rotor plates to facilitate relative rotation. A motor may include a stator and a rotor as described.

A method of changing a skew of an electric motor as described above includes reducing a commanded motor torque, then causing the hollow shaft to slide with respect to the rotor shaft such that a subset of the rotor plates rotates with respect to other rotor plates, and then increasing the commanded motor torque. The hollow shaft may be caused to slide by injecting pressurized fluid into a first chamber. Injecting pressurized fluid into a second chamber may causing the hollow shaft to return to its original position. Before causing the hollow shaft to slide, a clamping force on the plurality of rotor plates may be relieved. After causing the hollow shaft to slide, the clamping force may be re-applied. Lubricating fluid may be routed to spaces between the rotor plates.

A motor includes a stator, a rotor shaft, a hollow shaft, a plurality of rotor plates, and a controller. The rotor shaft is supported for rotation with respect to the stator. The hollow shaft is configured to slide axially with respect to the rotor shaft. The hollow shaft has a plurality of external spiral keys having different spiral angles from one another. The plurality of rotor plates is arranged along the hollow shaft. Each of the rotor plates defines a keyseat interfacing with one of the external spiral keys. The controller is programmed to command an actuator to slide the hollow shaft axially such that the rotor plates rotate with respect to one another to vary a skew of the motor. The motor may also include an end stop fixed to the rotor shaft and configured to axially position the plurality of rotor plates on one end with respect to the rotor shaft. The motor may also include a cylinder fixed to the rotor shaft on an opposite side of the plurality of rotor plates from the end stop and a piston configured to slide with respect to the cylinder toward the end stop in response to hydraulic pressure to selectively compress the plurality of rotor plates. The controller may be programmed to relieve a hydraulic pressure on the cylinder before commanding the actuator to slide the hollow shaft axially and to apply the hydraulic pressure on the cylinder after commanding the actuator to slide the hollow shaft axially. The hollow shaft and either the end stop or the cylinder may define a first chamber. The controller may command the actuator to slide the hollow shaft axially by increasing a pressure of a fluid in the first chamber. The hollow shaft and either the end stop or the cylinder may define a second chamber. The controller may be programmed to move the hollow shaft in an opposite direction by increasing a pressure of fluid in the second chamber. The rotor shaft may define an axial passageway and the rotor shaft and hollow shaft each define radial passageways configured to route lubrication fluid to spaces between the rotor plates of the plurality of rotor plates to facilitate relative rotation.

### BRIEF DESCRIPTION OF THE DRAWINGS

FIG. 1 is a block diagram of an electric vehicle.

FIG. 2 is a schematic cross sectional view of an electric motor.

FIG. 3 is a side cross-sectional view of a variable skew rotor.

FIG. 4 is an end view of a hollow shaft suitable for use in the variable skew rotor of FIG. 3.

FIGS. 5A to 5C are side views of the hollow shaft of FIG. 4.

FIG. 6 is an end cross-sectional view of the variable skew rotor of FIG. 3.

FIGS. 7A and 7B show a permanent magnet rotor in unskewed and skewed configurations, respectively.

FIG. 8 is a flow chart for a method of adjusting the skew of the rotor of FIGS. 3-6.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

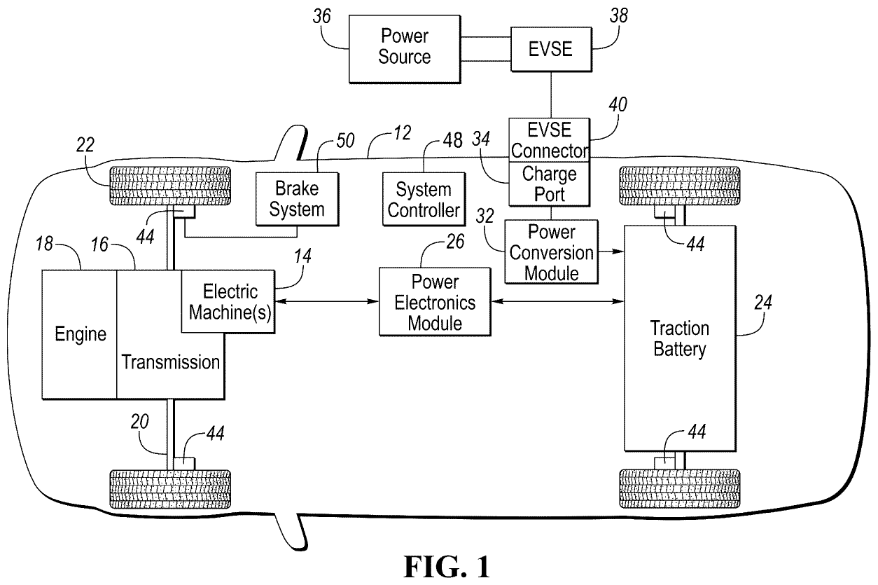

Referring now to FIG. 1, a block diagram of an exemplary electric vehicle (“EV”) 12 is shown. In this example, EV 12 is a plug-in hybrid electric vehicle (PHEV). EV 12 includes one or more electric machines 14 (“e-machines”) mechanically connected to a transmission 16. Electric machine 14 is capable of operating as a motor and as a generator. Transmission 16 is mechanically connected to an engine 18 and to a drive shaft 20 mechanically connected to wheels 22. Electric machine 14 can provide propulsion and slowing capability while engine 18 is turned on or off. Electric machine 14 may reduce vehicle emissions by allowing engine 18 to operate at more efficient speeds and allowing EV 12 to be operated in electric mode with engine 18 off under certain conditions.

A traction battery 24 (“battery) stores energy that can be used by electric machine 14 for propelling EV 12. Battery 24 typically provides a high-voltage (HV) direct current (DC) output. Battery 24 is electrically connected to a power electronics module 26. Power electronics module 26 is electrically connected to electric machine 14 and provides the ability to bi-directionally transfer energy between battery 24 and the electric machine. For example, battery 24 may provide a DC voltage while electric machine 14 may require a three-phase alternating current (AC) voltage to function. Power electronics module 26 may convert the DC voltage to a three-phase AC voltage to operate electric machine 14. In a regenerative mode, power electronics module 26 may convert three-phase AC voltage from electric machine 14 acting as a generator to DC voltage compatible with battery 24.

Battery 24 is rechargeable by an external power source 36 (e.g., the grid). Electric vehicle supply equipment (EVSE) 38 is connected to external power source 36. EVSE 38 provides circuitry and controls to control and manage the transfer of energy between external power source 36 and EV 12. External power source 36 may provide DC or AC electric power to EVSE 38. EVSE 38 may have a charge connector 40 for plugging into a charge port 34 of EV 12. Charge port 34 may be any type of port configured to transfer power from EVSE 38 to EV 12. A power conversion module 32 of EV 12 may condition power supplied from EVSE 38 to provide the proper voltage and current levels to battery 24. Power conversion module 32 may interface with EVSE 38 to coordinate the delivery of power to battery 24. Alternatively, various components described as being electrically connected may transfer power using a wireless inductive coupling.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 48 (i.e., a vehicle controller) is present to coordinate the operation of the various components.

As described, EV 12 is in this example is a PHEV having engine 18 and battery 24. In other embodiments, EV 12 is a battery electric vehicle (BEV). In a BEV configuration, EV 12 does not include an engine.

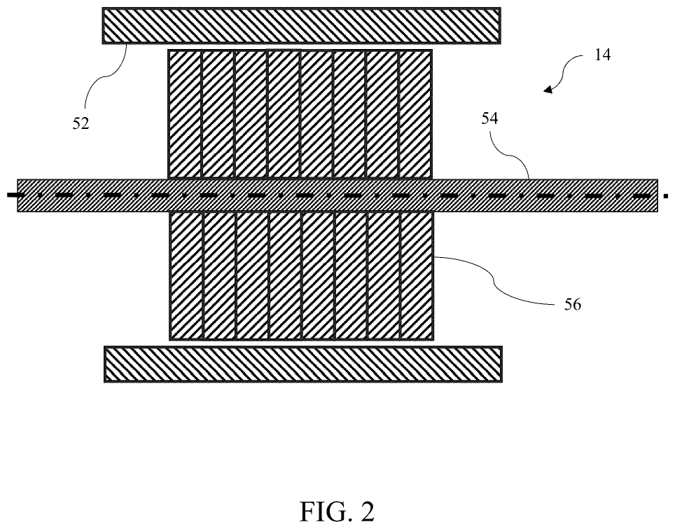

FIG. 2 illustrates an electric motor. Stator 52 is fixed to vehicle structure. A set of electrical windings are installed on stator 52 to create magnetic fields by adjusting the current level in the wires. Rotor shaft 54 is supported for rotation with respect to the stator and adapted for rotary connection to powertrain components. A set of rotor plates 56 are rotationally coupled to rotor shaft 54. Each rotor plate has a set of permanent magnets installed with alternating polarity. The magnetic field of the permanent magnets interacts with the magnetic field produced by the stator winding to create torque which is transmitted to the rotor shaft. The torque on a particular plate fluctuates cyclically as the rotor plate rotates relative to the stator. In some operating conditions, such as low speed, high torque operation, these fluctuations, called ripple, can be detected by vehicle occupants. In an unskewed configuration, the magnets of the plates are axially aligned with one another such that the fluctuations are synchronized and additive. In a skewed configuration, the magnets of some rotor plates are circumferentially offset somewhat relative to one another. As a result, the fluctuations are slightly out of phase with one another such that the sum of the torques produced by the set of plates fluctuates less. Although this reduces torque ripple, it also reduces the maximum achievable torque. Conventionally, motor designers must compromise by selecting a degree of skewing which is less than optimal in some operating conditions and more than optimal in other operating conditions.

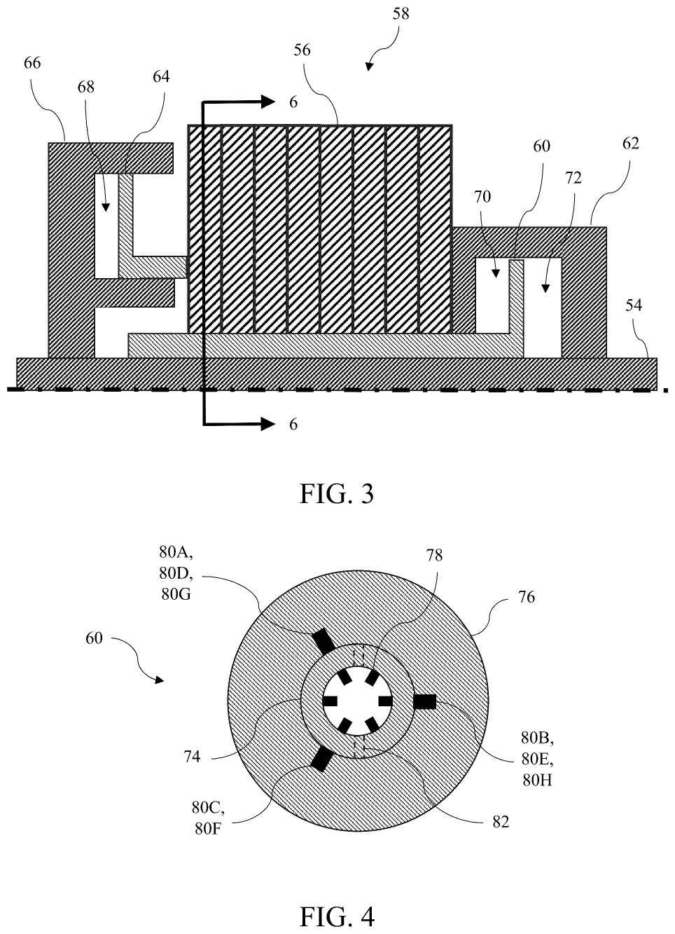

FIG. 3 illustrates a rotor 58 that is designed to vary the degree of skew dynamically. The rotor is axis-symmetric, so only the top half is shown. A hollow shaft 60 is configured to slide axially with respect to rotor shaft 54. For example, hollow shaft 60 may have an internal spline that interfaces with an external spline on rotor shaft 54 to transmit torque but allow axial movement. The rotor plates 56 are indirectly coupled to rotor shaft 54 via hollow shaft 60. As will be discussed in detail below, sliding hollow shaft 60 axially changes the degree of skew of the rotor plates 56.

End stop 62 axially positions one end of the stack of rotor plates (the right end in FIG. 3) with respect to rotor shaft 54. End stop 62 is axially fixed to rotor shaft 54. The other end of the stack of rotor plates is axially positioned by piston 64. Cylinder 66 is axially fixed to rotor shaft 54. When pressurized fluid is routed into a chamber 68 defined between cylinder 66 and piston 64, piston 64 is forced toward the right and applies a compressive force to the stack of rotor plates. The fluid may be routed to chamber 68, for example, via passageways in rotor shaft 54 and in cylinder 66. In alternative embodiments, an electrical actuator, mechanical actuator, or other type of actuator may be substituted for the hydraulic actuator formed by cylinder 66 and piston 64.

End stop 62 and hollow shaft 60 for two chambers 70 and 72. Routing pressurized fluid to chamber 70 while venting chamber 72 causes hollow shaft 60 to move to the right with respect to rotor shaft 54. Similarly, routing pressurized fluid to chamber 72 while venting chamber 70 causes hollow shaft 60 to move to the left. The fluid may be routed, for example, via passageways in rotor shaft 54 and end stop 62. In alternative embodiments, a spring may be utilized to bias hollow shaft 60 in one direction, eliminating the need for one of the two chambers. In other alternative embodiments, one or both chambers may be formed between hollow shaft 60 and cylinder 66 as opposed to between hollow shaft 60 and end stop 62. In yet other embodiments, electrical actuation, mechanical actuation, or other actuation means may be used to vary the axial position of hollow shaft 60 with respect to rotor shaft 54.

FIG. 4 is an end view of hollow shaft 60. Hollow shaft 60 includes a shaft body 74 and a flange 76. They flange 76 interacts with either the end stop of the cylinder to form the hydraulic actuator to move the hollow shaft axially as described previously. The shaft body includes internal spline teeth 78 which rotationally couple hollow shaft 60 to rotor shaft 54. A set of external keys 80A-80H are arranged around the body 74 of the hollow shaft. The external keys may be integrally formed with the shaft or may be fabricated separately. In the illustrated embodiment, there are eight external keys arranged in three rows. In other embodiments, the number of keys and the number of rows may be different. At least one of the external keys is an external spiral key, meaning that the different circumferential position relative to the hollow shaft varies at various axial positions of the key. At several axial locations, there may be axial lubrication passageways 82 in the shaft body 74.

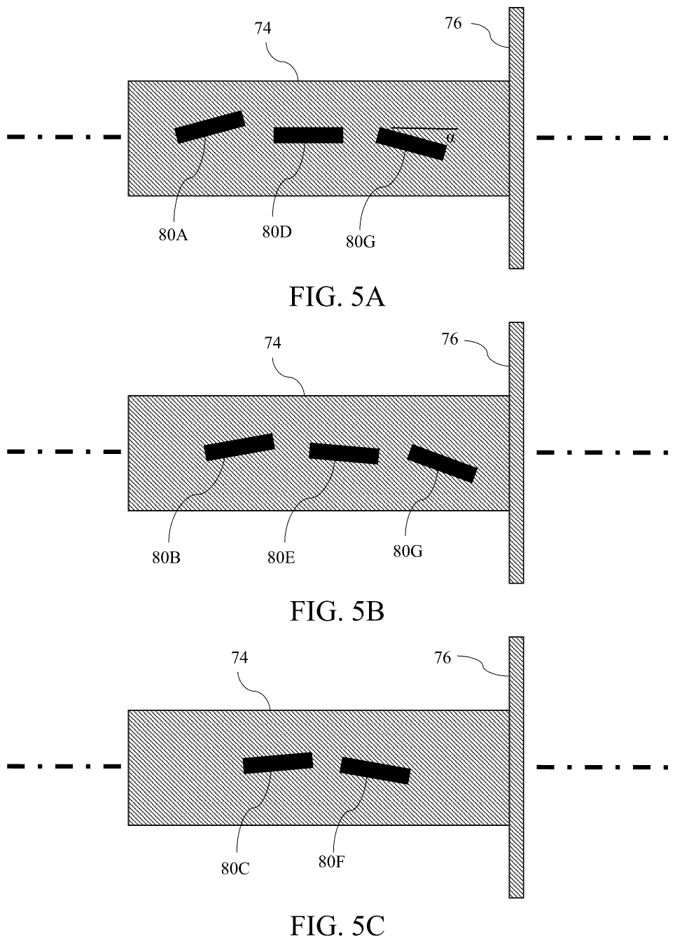

FIGS. 5A-5C are side views of hollow shaft 60 from different sides. FIG. 5A illustrates external keys 80A, 80D, and 80G. FIG. 5B illustrates external keys 80B, 80E, and 80H. FIG. 5A illustrates external keys 80C and 80F. Each external key has a spiral angle, α, between the axis of the key and the axis of the shaft. (This is illustrated only for external key 80G.) One of the external keys, 80D, has a spiral angle of zero. The remaining external keys in the illustrated embodiment are external spiral keys, each having different spiral angles.

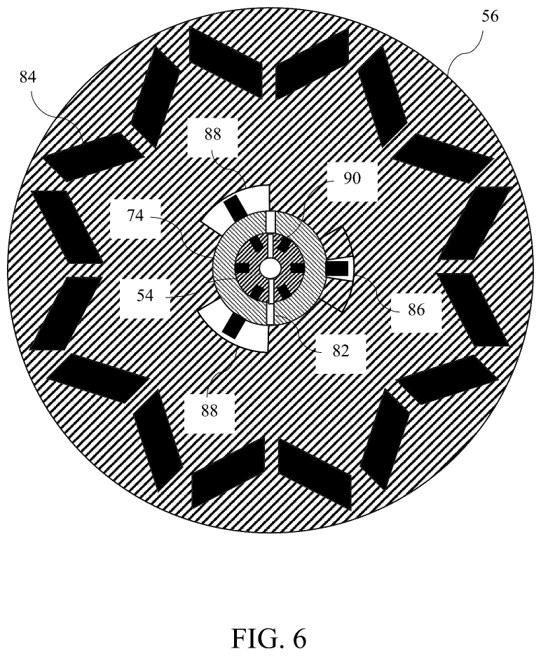

FIG. 6 is a cross-sectional view through the rotor assembly illustrating how some of the components fit together. Permanent magnets 84 are embedded in the rotor plate 56. The rotor plate defines a keyseat 86 which interfaces with one of the external keys of hollow shaft 60 to circumferentially position the rotor plate relative to the hollow shaft. A keyseat is a feature that interacts with a key to position two components with respect to one another. Also, torque is transmitted from the rotor plate 56 to the hollow shaft 60 via the keyseat to key interface. The rotor plate may have clearance openings 88 around other keys that positions adjacent rotor plates. Rotor shaft 54 may define a central axial passageway and number of radial passageways 90 to convey lubrication fluid. The radial passageways 90 may be connected to radial passageways 82 of the hollow shaft to route lubrication fluid to spaces between the rotor plates facilitating the relative rotation that occurs when varying the skew or the rotor.

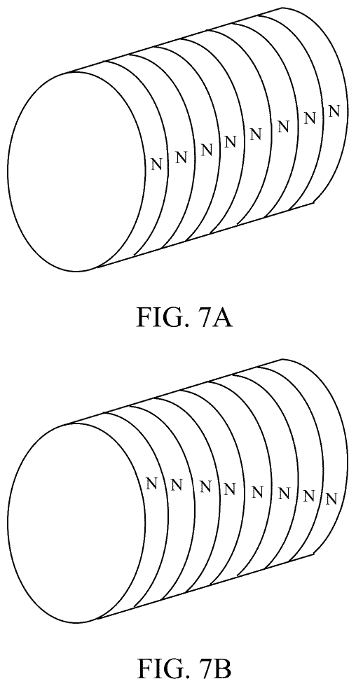

FIG. 7A illustrates a rotor having a set of rotor plates in which the North poles of the permanent magnets are aligned such that they each pass a respective pole of the stator at the same time. This is referred to as an unskewed configuration. FIG. 7B illustrates a rotor in a skewed configuration. The North poles of the plates are not aligned and would pass a pole of the stator at slightly different times as the rotor rotates with respect to the stator. The degree of skew is exaggerated for illustrative purposes.

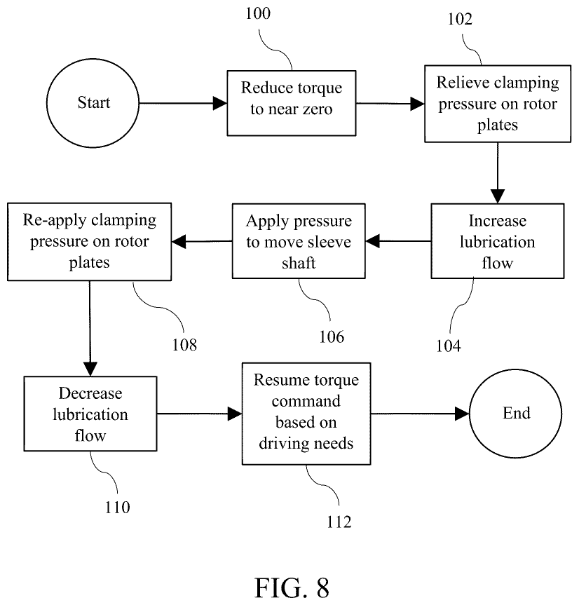

FIG. 8 is a flowchart for a process of adjusting skew of the rotor of FIGS. 3 to 6. This process would be executed by a controller such as controller 48 of FIG. 1. Some steps of the process may be omitted in some embodiments. At 100, the controller reduces the commanded torque to near zero. Transmission of significant torque during the skew change operation may make it difficult to slide the hollow shaft axially due to friction between components. At 102, the controller relieves the clamping pressure on the rotor plates by venting the fluid in chamber 68. At 104, the controller increases a flow rate of lubrication fluid that is routed between the rotor plates via lubrication passageways in rotor shaft 54 and hollow shaft 60. This fluid helps to separate the rotor plates from one another to facilitate relative rotation. At 106, the controller increases a pressure of fluid in either chamber 70 or 72, depending on whether skew is to be increased or decreased, while venting fluid from the other chamber. Once the hollow shaft has moved by the desired amount, both chambers may be pressurized or both chambers may be de-pressurized. Next, at 108, the controller increases the pressure of fluid in chamber 68 to re-apply the clamping force. At 110, the lubrication flow rate is reduced. Finally, at 112, the commanded torque is set based on the vehicle propulsion requirements.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A rotor comprising:
a rotor shaft;
a hollow shaft configured to slide axially with respect to the rotor shaft, the hollow shaft having at least one external spiral key; and
a plurality of rotor plates arranged along the hollow shaft, at least one of the rotor plates being a variable skew rotor plate, the variable skew rotor plate defining a keyseat interfacing with the external spiral key such that the variable skew rotor plate rotates with respect to the rotor shaft in response to axial movement of the hollow shaft.

2. The rotor of claim 1 wherein:
the at least one external spiral key includes a plurality of external spiral keys having different spiral angles from one another; and
the plurality of rotor plates includes a plurality of variable skew rotor plates, each defining a keyseat interfacing with one of the external spiral keys such that the variable skew rotor plate rotates by different amounts with respect to the rotor shaft in response to axial movement of the hollow shaft.

3. The rotor of claim 2 wherein the plurality of rotor plates further includes at least one fixed rotor plate which does not rotate with respect to the rotor shaft in response to axial movement of the hollow shaft.

4. The rotor of claim 1 further comprising an end stop fixed to the rotor shaft and configured to axially position the plurality of rotor plates on one end with respect to the rotor shaft.

5. The rotor of claim 4 further comprising:
a cylinder fixed to the rotor shaft on an opposite side of the plurality of rotor plates from the end stop; and
a piston configured to slide with respect to the cylinder toward the end stop in response to hydraulic pressure to selectively compress the plurality of rotor plates.

6. The rotor of claim 5 wherein the hollow shaft and one of the end stop and the cylinder define a first chamber such that injecting pressurized fluid into the first chamber moves the hollow shaft axially in a first direction.

7. The rotor of claim 6 wherein the hollow shaft and one of the end stop and the cylinder define a second chamber such that injecting pressurized fluid into the second chamber moves the hollow shaft axially in a second direction opposite the first direction.

8. The rotor of claim 1 wherein the rotor shaft defines an axial passageway and the rotor shaft and the hollow shaft each define radial passageways configured to route lubrication fluid to spaces between the rotor plates of the plurality of rotor plates to facilitate relative rotation.

9. A motor comprising:
a stator; and
a rotor according to claim 1 supported for rotation with respect to the stator.

10. A method of changing a skew of an electric motor, the electric motor having a rotor shaft, a hollow shaft configured to slide axially with respect to the rotor shaft, and a plurality of rotor plates coupled to the hollow shaft via keys, the method comprising:
reducing a commanded motor torque;
after reducing the commanded torque, causing the hollow shaft to slide with respect to the rotor shaft such that a subset of the rotor plates rotates with respect to other rotor plates; and
after causing the hollow shaft to slide, increasing the commanded motor torque.

11. The method of claim 10 wherein causing the hollow shaft to slide comprises injecting pressurized fluid into a first chamber.

12. The method of claim 11 further comprising injecting pressurized fluid into a second chamber causing the hollow shaft to return to an original position.

13. The method of claim 10 further comprising:
before causing the hollow shaft to slide, relieving a clamping force on the plurality of rotor plates; and
after causing the hollow shaft to slide, applying the clamping force on the plurality of rotor plates.

14. The method of claim 10 further comprising routing a lubricating fluid to spaces between the rotor plates.

15. A motor comprising:
a stator;
a rotor shaft supported for rotation with respect to the stator;
a hollow shaft configured to slide axially with respect to the rotor shaft, the hollow shaft having a plurality of external spiral keys having different spiral angles from one another;
a plurality of rotor plates arranged along the hollow shaft, each of the rotor plates defining a keyseat interfacing with one of the external spiral keys; and
a controller programmed to command an actuator to slide the hollow shaft axially such that the rotor plates rotate with respect to one another to vary a skew of the motor.

16. The motor of claim 15 further comprising an end stop fixed to the rotor shaft and configured to axially position the plurality of rotor plates on one end with respect to the rotor shaft.

17. The motor of claim 16 further comprising:
a cylinder fixed to the rotor shaft on an opposite side of the plurality of rotor plates from the end stop; and
a piston configured to slide with respect to the cylinder toward the end stop in response to hydraulic pressure to selectively compress the plurality of rotor plates; wherein
the controller is programmed to relieve a hydraulic pressure on the cylinder before commanding the actuator to slide the hollow shaft axially and to apply the hydraulic pressure on the cylinder after commanding the actuator to slide the hollow shaft axially.

18. The motor of claim 17 wherein the hollow shaft and one of the end stop and the cylinder define a first chamber and wherein commanding the actuator to slide the hollow shaft axially comprises increasing a pressure of a fluid in the first chamber.

19. The motor of claim 18 wherein the hollow shaft and one of the end stop and the cylinder define a second chamber and wherein the controller is programmed to move the hollow shaft in an opposite direction by increasing a pressure of fluid in the second chamber.

20. The motor of claim 15 wherein the rotor shaft defines an axial passageway and the rotor shaft and hollow shaft each define radial passageways configured to route lubrication fluid to spaces between the rotor plates of the plurality of rotor plates to facilitate relative rotation.
